(19) United States
(12) Patent Application Publication
(10) Pub. No.: US 2023/0416138 A1
(43) Pub. Date: Dec. 28, 2023

(54) APPARATUS FOR CUTTING GLASS LAMINATED SUBSTRATE

(71) Applicant: CORNING INCORPORATED, CORNING, NY (US)

(72) Inventor: Woo Jin Lee, Cheonan (KR)

(21) Appl. No.: 18/036,802

(22) PCT Filed: Nov. 10, 2021
(86) PCT No.: PCT/US2021/058715

§ 371 Date: May 12, 2023

(30) Foreign Application Priority Data
Nov. 19, 2020 (KR) 10-2020-0155429

(51) Int. Cl. C03B 33/07; C03B 33/10; B24B 9/08

(52) U.S. Cl. CPC C03B 33/076; C03B 33/105; B24B 9/08

(57) ABSTRACT

Provided is an apparatus for cutting a glass laminated substrate, the apparatus including a first rotating plate, a second rotating plate, and a connection member interposed between the first rotating plate and the second rotating plate and configured to rotate around the first axis, in which a channel having a ring shape surrounding an outer circumferential surface of the connection member is formed between the first rotating plate and the second rotating plate.

### CROSS-REFERENCE TO RELATED APPLICATION

This application is based on and claims priority under 35 U.S.C. § 119 to Korean Patent Application No. 10-2020-0155429, filed on Nov. 19, 2020, in the Korean Intellectual Property Office, the disclosure of which is incorporated by reference herein in its entirety.

### BACKGROUND

### 1. Field

The inventive concept relates to an apparatus for cutting a glass laminated substrate, and more particularly, to an apparatus for cutting a glass laminated substrate, the apparatus being capable of reducing damage to a glass layer.

### 2. Description of Related Art

A glass laminated substrate may be cut to various sizes by using a cutting apparatus. For example, a glass laminated substrate may be cut through cutting techniques such as a CNC router, a water jet, and drilling. An apparatus for cutting a glass laminated substrate, which may reduce damage to a glass layer in a process of cutting a glass laminated substrate, is actively under development.

### SUMMARY

The inventive concept provides an apparatus for cutting a glass laminated substrate, the apparatus being capable of reducing damage to a glass layer in a process of cutting a glass laminated substrate.

Furthermore, the inventive concept provides an apparatus for cutting a glass laminated substrate, the apparatus being capable of smoothly cutting a cutting surface of the glass laminated substrate in a process of cutting a glass laminated substrate.

Additional aspects will be set forth in part in the description which follows and, in part, will be apparent from the description, or may be learned by practice of the presented embodiments of the disclosure.

According to an aspect of the inventive concept, there is provided an apparatus for cutting a glass laminated substrate, which includes a first rotating plate configured to rotate around a first axis extending in a first direction parallel to a direction in which an upper surface of the glass laminated substrate extends, a first cutter coupled to an edge of the first rotating plate, a second rotating plate disposed apart from the first rotating plate in the first direction and configured to rotate around the first axis, a second cutter coupled to an edge of the second rotating plate and disposed apart from the first cutter in the first direction, and a connection member interposed between the first rotating plate and the second rotating plate and configured to rotate around the first axis, wherein a channel having a ring shape surrounding an outer circumferential surface of the connection member is formed between the first rotating plate and the second rotating plate.

In an embodiment, the first rotating plate, the second rotating plate, and the connection member may be integrally formed.

In an embodiment, the apparatus may have a symmetrical shape with respect to the first axis that passes the centers of the first rotating plate, the second rotating plate, and the connection member.

In an embodiment, the apparatus may have a symmetrical shape with respect to a second axis that is perpendicular to the first axis and vertically passes the center and the outer circumferential surface of the connection member.

In an embodiment, a width of the first cutter in the first direction may be identical to a width of the second cutter in the first direction, and a width of the channel in the first direction may be about ⅔ times to about two times greater than the width of each of the first cutter and the second cutter.

In an embodiment, a width of the channel in the first direction may be greater than the width of each of the first cutter and the second cutter.

In an embodiment, a width of the first cutter in the first direction, a width of the second cutter in the first direction, and a width of the channel in the first direction may be identical to one another.

In an embodiment, the first cutter and the second cutter each may have a tapered shape in which a cross-sectional area of each of the first cutter and the second cutter on a plane perpendicular to a second direction gradually decreases in the second direction, the second direction being a direction away from the outer circumferential surface of the connection member.

In an embodiment, a direction perpendicular to the first direction and being away from the outer circumferential surface of the connection member may be defined as a second direction, and a depth of the channel in the second direction may be about 1.5 times to about 5 times greater than each of a thickness of the first cutter in the second direction and a thickness of the second cutter in the second direction.

According to another aspect of the inventive concept, there is provided an apparatus for cutting a glass laminated substrate in which a substrate, an adhesive layer, and a glass layer are sequentially stacked, which includes a first rotating plate configured to rotate around a first axis extending in a direction parallel to a first direction in which a surface of the glass laminated substrate extends, a first cutter coupled to an edge of the first rotating plate to surround a center portion of the first rotating plate and configured to process the glass layer and a portion of the adhesive layer, a second rotating plate disposed apart from the first rotating plate in the first direction and configured to rotate around the first axis, a second cutter coupled to an edge of the second rotating plate to surround a center portion of the second rotating plate and configured to process the glass layer and a portion of the adhesive layer, a connection member interposed between inner surfaces of the first rotating plate and the second rotating plate and configured to rotate around the first axis, wherein a channel having a ring shape surrounding an outer circumferential surface of the connection member is formed between the first rotating plate and the second rotating plate, glass debris of the glass layer that is cut by the first cutter and the second cutter being discharged through the channel.

In an embodiment, the first rotating plate, the second rotating plate, and the connection member may be integrally formed, and the apparatus may have a symmetrical shape with respect to the first axis that passes the centers of the first rotating plate, the second rotating plate, and the connection member.

In an embodiment, the apparatus may have a symmetrical shape with respect to a second axis that is perpendicular to the first axis and vertically passes the center and the outer circumferential surface of the connection member.

In an embodiment, a direction perpendicular to the first direction and being away from the outer circumferential surface of the connection member may be defined as a second direction, the first cutter may include a first processing portion that comes into contact with the glass layer and the adhesive layer during processing of the glass laminated substrate and includes a diamond and a first connection portion connecting the first processing portion to the first rotating plate, the second cutter may include a second processing portion that comes into contact with the glass layer and the adhesive layer during the processing of the glass laminated substrate and includes a diamond and a second connection portion connecting the second processing portion to the second rotating plate, and a thickness of the first processing portion in the second direction and a thickness of the second processing portion in the second direction each may be greater than a thickness of the glass layer.

In an embodiment, when a thickness of the glass layer of the glass laminated substrate is about 100 micrometers to about 150 micrometers, the thickness of the first processing portion of the first cutter and the thickness of the second processing portion of the second cutter each may exceed about 150 micrometers.

In an embodiment, the first processing portion and the second processing portion each may have a tapered shape in which a cross-sectional area of each of the first processing portion and the second processing portion on a plane perpendicular to the second direction gradually decreases in the second direction, the second direction being a direction away from the outer circumferential surface of the connection member.

In an embodiment, the first processing portion of the first cutter may include a first cutting surface facing the glass laminated substrate and a first side surface extending from the first cutting surface, the second processing portion of the second cutter may include a second cutting surface facing the glass laminated substrate and a second side surface extending from the second cutting surface, and an inclination angle formed by the first cutting surface and the first side surface of the first processing portion, and an inclination angle formed by the second cutting surface and the second side surface of the second processing portion, each may be about 15° to about 75°.

In an embodiment, a surface roughness of the first processing portion of the first cutter may be less than a surface roughness of the first connection portion, and a surface roughness of the second processing portion of the second cutter may be less than a surface roughness of the second connection portion.

In an embodiment, a width of the first cutter in the first direction may be identical to a width of the second cutter in the first direction, and a width of the channel in the first direction may be about ⅔ times to about 2 times greater than the width of each of the first cutter and the second cutter.

In an embodiment, the width of the first cutter in the first direction, the width of the second cutter in the first direction, and the width of the channel in the first direction may be identical to one another.

In an embodiment, the width of the first cutter in the first direction, the width of the second cutter in the first direction, and the width of the channel in the first direction each may be about 0.5 millimeters to about 3 millimeters.

The apparatus for cutting a glass laminated substrate according to an embodiment of the inventive concept may provide an external discharge path of glass debris generated due to etching of the glass layer, and may have a channel for providing a space in which a cooling material flows.

Accordingly, the apparatus for cutting a glass laminated substrate according to and embodiment of the inventive concept may cut the glass laminated substrate while reducing physical damage to the glass layer.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a schematic view of a glass laminated substrate and a cross-section thereof;

FIG. 2A is a side view of an apparatus for cutting a glass laminated substrate according to a comparative example;

FIG. 2B is a cross-sectional view of an apparatus for cutting a glass laminated substrate according to a comparative example;

FIG. 3 is a view showing cutting of a glass layer of a glass laminated substrate by using an apparatus for cutting a glass laminated substrate according to a comparative example;

FIG. 4 is a perspective view of an apparatus for cutting a glass laminated substrate according to an embodiment of the inventive concept;

FIG. 5 a side view of an apparatus for cutting a glass laminated substrate according to an embodiment of the inventive concept;

FIG. 6 is a cross-sectional view of an apparatus for cutting a glass laminated substrate according to an embodiment of the inventive concept;

FIG. 7 is an enlarged view of a portion A of FIG. 6;

FIG. 8 is an enlarged view of a portion of an apparatus for cutting a glass laminated substrate according to an embodiment of the inventive concept;

FIG. 9 is a view for explaining a method of manufacturing a first cutter of the apparatus for cutting a glass laminated substrate of FIG. 8, according to an embodiment of the inventive concept;

FIG. 10 is an enlarged view of a portion of an apparatus for cutting a glass laminated substrate according to an embodiment of the inventive concept;

FIG. 11 is a flowchart of a method of cutting a glass laminated substrate according to an embodiment of the inventive concept; and

FIGS. 12 to 16 are views showing operations of a method of cutting a glass laminated substrate according to an embodiment of the inventive concept.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Embodiments of the inventive concept will now be described below in detail with reference to the accompanying drawings. The disclosure may, however, be embodied in many different forms and should not be construed as being limited to the embodiments set forth herein;
rather, these embodiments are provided so that this disclosure will be thorough and complete, and will fully convey the concept of the disclosure to those of ordinary skill in the art. Like reference numerals denote like constituent elements Furthermore, various elements and areas in the drawings are schematically drawn. Accordingly, the inventive concept is not limited by relative sizes or intervals drawn in the accompanying drawings.

Terms such as “first” and “second” are used herein merely to describe a variety of constituent elements, but the constituent elements are not limited by the terms. Such terms are used only for the purpose of distinguishing one constituent element from another constituent element. For example, without departing from the right scope of the disclosure, a first constituent element may be referred to as a second constituent element, and vice versa.

Terms used in the specification are used for explaining a specific embodiment, not for limiting the disclosure. An expression used in a singular form in the specification also includes the expression in its plural form unless clearly specified otherwise in context. Also, terms such as “include” or “comprise” may be construed to denote a certain characteristic, number, step, operation, constituent element, or a combination thereof, but may not be construed to exclude the existence of or a possibility of addition of one or more other characteristics, numbers, steps, operations, constituent elements, or combinations thereof.

Unless defined otherwise, all terms used herein including technical or scientific terms have the same meanings as those generally understood by those of ordinary skill in the art to which the disclosure may pertain. Furthermore, the terms as those defined in generally used dictionaries are construed to have meanings matching that in the context of related technology and, unless clearly defined otherwise, are not construed to be ideally or excessively formal.

When a certain embodiment may be implemented differently, a specific process order may be performed differently from the described order. For example, two consecutively described processes may be performed substantially at the same time or performed in an order opposite to the described order.

In the drawings, the illustrated shapes may be modified according to, for example, manufacturing technology and/or tolerance. Thus, the embodiment of the disclosure may not be construed to be limited to a particular shape of a part described in the specification and may include a change in the shape generated during manufacturing, for example. As used herein, the term “and/or” includes any and all combinations of one or more of the associated listed items.

Furthermore, the term “substrate” used herein may mean a substrate by itself, or a stack structure including a substrate and a certain layer or film formed on a surface thereof. Furthermore, the term “surface of a substrate” used herein may mean an exposed surface of a substrate by itself, or an external surface such as a certain layer or film formed on the substrate.

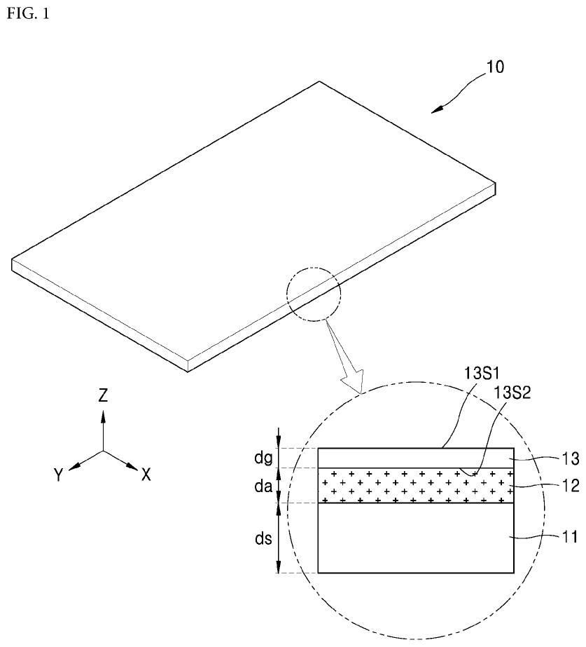

FIG. 1 is a schematic view of a glass laminated substrate 10 with a cross-section thereof.

Referring to FIG. 1, the glass laminated substrate 10 may include a substrate 11, a glass layer 13 laminated on the substrate 11, and an adhesive layer 12 for laminating the glass layer 13 on the substrate 11. For example, the glass laminated substrate 10 may be a substrate in which the substrate 11, the adhesive layer 12, and the glass layer 13 are sequentially stacked.

The substrate 11 may include a material such as metal, wood, an inorganic material, an organic material, or a combination thereof, but the disclosure is not limited thereto. For example, the substrate 11 may include a high pressure laminate (HPL), paint-coated metal (PCM), a medium density fiberboard (MDF), vinyl-coated metal (VCM), or steel, but the disclosure is not limited thereto. In an embodiment, a thickness ds of the substrate 11 may be about 500 micrometers or more.

The glass layer 13 may include, for example, borosilicate, aluminosilicate, boro-aluminosilicate, alkali-borosilicate, alkali-aluminosilicate, alkali-boro-aluminosilicate, or soda lime, but the disclosure is not limited thereto.

Among surfaces of the glass layer 13, a surface forming the top layer of the glass laminated substrate 10 may be defined as a first surface 13S1. For example, the first surface 13S1 of the glass layer 13 may be an upper surface of the glass layer 13 exposed to the outside. Furthermore, among the surfaces of the glass layer 13, a surface contacting the adhesive layer 12 may be defined as a second surface 13S2. For example, the second surface 13S2 of the glass layer 13 may be a lower surface of the glass layer 13 that is opposite to the first surface 13S1 and is not exposed to the outside.

In an embodiment, a thickness dg of the glass layer 13 may be about 25 micrometers or more. For example, the thickness dg of the glass layer 13 may be about 25 micrometers to about 700 micrometers. In particular, the thickness dg of the glass layer 13 may be about 100 micrometers to about 150 micrometers.

The adhesive layer 12 may be a layer for fixedly bonding the substrate 11 and the glass layer 13. For example, the adhesive layer 12 may include s pressure sensitive adhesive (PSA), optically clear resin (OCR), or optically clear adhesive (OCA), but the disclosure is not limited thereto.

In an embodiment, a thickness da of the adhesive layer 12 may be about 50 micrometers to about 300 micrometers. In particular, the thickness da of the adhesive layer 12 may be about 75 micrometers to about 125 micrometers.

In an embodiment, the glass laminated substrate 10 may further include an image film layer (not shown) between the substrate 11 and the adhesive layer 12. The image film layer may be a film formed by printing an image layer on a polymer base.

The polymer base may include, for example, a polypropylene (PP) film and a polyethylene terephthalate (PET) film, a polystyrene (PS) film, an acrylonitrile butadiene styrene (ABS) resin film, a high density polyethylene (HDPE) film, a low density polyethylene (LDPE) film, a polyvinyl chloride (PVC) film, a polyethylene naphthalate film, a polybutylene terephthalate film, a polycarbonate (PC) film, or a stacked film thereof.

In an embodiment, the image layer may be a printing layer on which characters, pictures, symbols, and the like are printed. The image layer may be formed by, for example, inkjet printing or laser printing. The image layer may include a pigment component of ink for inkjet printers, or a pigment component of tone for laser printers.

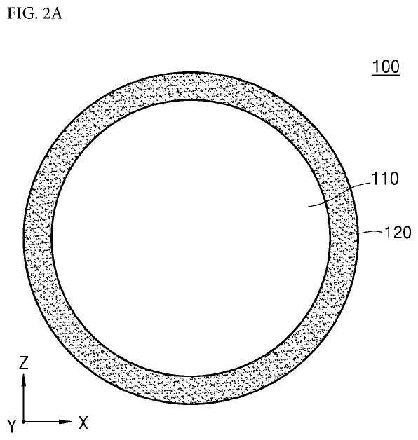

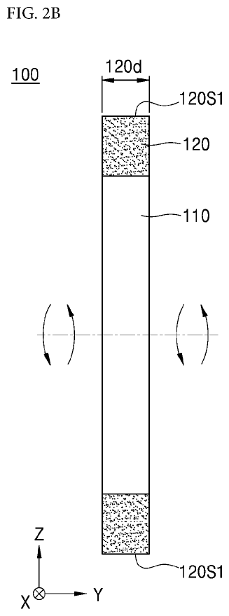

FIG. 2A is a side view of a cutting apparatus 100 of the glass laminated substrate 10 according to a comparative example. FIG. 2B is a cross-sectional view of the cutting apparatus 100 of the glass laminated substrate 10 according to a comparative example.

The cutting apparatus 100 of the glass laminated substrate 10 illustrated in FIGS. 2A and 2B may be an apparatus configured to cut the glass layer 13 of the glass laminated substrate 10 illustrated in FIG. 1. For example, the cutting apparatus 100 of the glass laminated substrate 10 may be an apparatus configured to cut the glass layer 13 in a direction, for example, an X direction, parallel to a direction in which the first surface 13S1 of the glass layer 13 of the glass laminated substrate 10 extends.

Referring to both FIGS. 2A and 2B, the cutting apparatus 100 of the glass laminated substrate 10 may include a rotating plate 110 and a cutter 120 coupled to an edge of the rotating plate 110.

The rotating plate 110 may be a plate configured to rotate around an axis in a direction perpendicular to a cutting direction of the glass laminated substrate 10. For example, when the cutting apparatus 100 cuts the glass laminated substrate 10 in an X direction, the rotating plate 110 may be configured to rotate around an axis extending in a Y direction perpendicular to the X direction.

The cutter 120 may be coupled to an edge of the rotating plate 110. Furthermore, while being coupled to the edge of the rotating plate 110, the cutter 120 may rotate substantially the same direction as a rotation direction of the rotating plate 110.

The cutter 120 may cut the glass layer 13 of the glass laminated substrate 10 through a rotation force. In other words, the cutter 120 may split the glass layer 13 into a plurality of parts by etching the glass layer 13 and a portion of the adhesive layer 12 through a rotation force.

The cutter 120 may have a cutting surface 120S1 facing the glass layer 13 during the cutting of the glass layer 13 of the glass laminated substrate 10 by the cutting apparatus 100. In other words, the cutting surface 120S1 of the cutter 120 may be a surface of the cutter 120 contacting the first surface 13S1 of the glass layer 13 during the cutting of the glass layer 13.

A width 120d of the cutting surface 120S1 of the cutter 120 may be a length of the cutter 120 in a direction parallel to a direction in which a rotation axis of the rotating plate 110 extends. For example, when the rotating plate 110 rotates around an axis in a direction parallel to the Y direction, the width 120d of the cutting surface 120S1 may be the length of the cutter 120 in the Y direction.

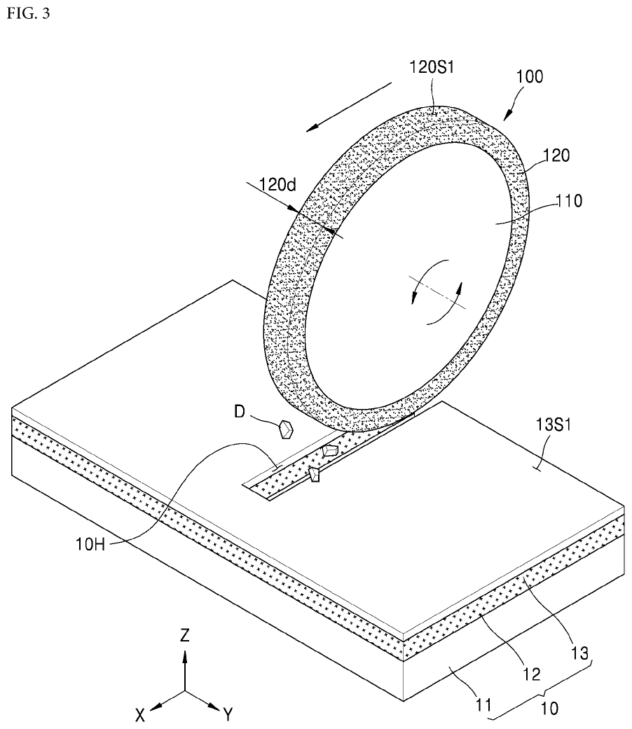

FIG. 3 is a view showing the cutting of the glass layer 13 of the glass laminated substrate 10 by using the cutting apparatus 100 of the glass laminated substrate 10 according to a comparative example.

Referring to FIG. 3, to cut the glass layer 13 of the glass laminated substrate in the X direction, the rotating plate 110 and the cutter 120 may rotate around the axis in the Y direction perpendicular to the X direction.

While rotating around the axis in the Y direction, the cutting apparatus 100 may move in the X direction across the first surface 13S1 of the glass laminated substrate 10. While the cutting apparatus 100 moves in the X direction, a portion of the cutter 120 may etch the glass layer 13 and a portion of the adhesive layer 12. When the cutting apparatus 100 completely traverse the glass laminated substrate 10 in the X direction, the glass layer 13 of the glass laminated substrate 10 may be split into a plurality of parts.

When the glass laminated substrate 10 is cut by the cutting apparatus 100, a glass debris D may be generated due to the etching of the glass layer 13. The size of the glass debris D of the glass layer 13 generated due to the cutting of the glass laminated substrate 10 may be affected by the width 120d of the cutting surface 120S1 of the cutter 120. For example, the maximum length of the glass debris D of the glass layer 13 may be within about ⅔ times of the width 120d of the cutting surface 120S1 of the cutter 120.

In an operation of cutting the glass layer 13 of the glass laminated substrate 10 by using the cutting apparatus 100, some of the glass debris D generated due to the etching of the glass layer 13 may not be discharged to the outside of the glass laminated substrate 10, and may be confined in the inside of a cutting groove 10H of the glass laminated substrate 10 generated due to the movement of the cutting apparatus 100. When the cutting apparatus 100 continuously cuts the glass laminated substrate 10 while the glass debris D is confined in the cutting groove 10H, the glass debris D may collide with the glass layer 13 to physically damage the glass layer 13.

Furthermore, in the operation of cutting the glass layer 13 of the glass laminated substrate 10 using the cutting apparatus 100, frictional heat may be generated due to a friction between the cutter 120 and the glass layer 13. The frictional heat may heat the cutter 120 and the glass layer 13. When the cutting apparatus 100 continuously cuts the glass laminated substrate 10 while the cutter 120 and the glass layer 13 are heated, the glass layer 13 may be physically damaged by the frictional heat. For example, cracks may be generated in the glass layer 13 by the frictional heat.

To solve the above-described problems, the cutting apparatus 200 of the glass laminated substrate 10 according to an embodiment of the inventive concept may be provided. In the following description, a cutting apparatus 200 of the glass laminated substrate 10 according to an embodiment of the inventive concept is described below in detail with reference to the accompanying drawings.

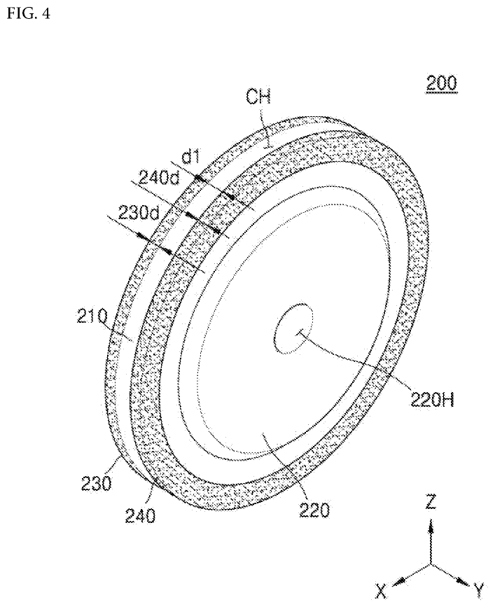

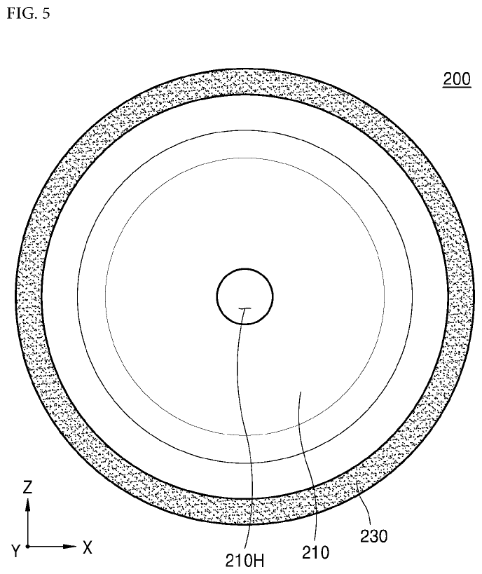

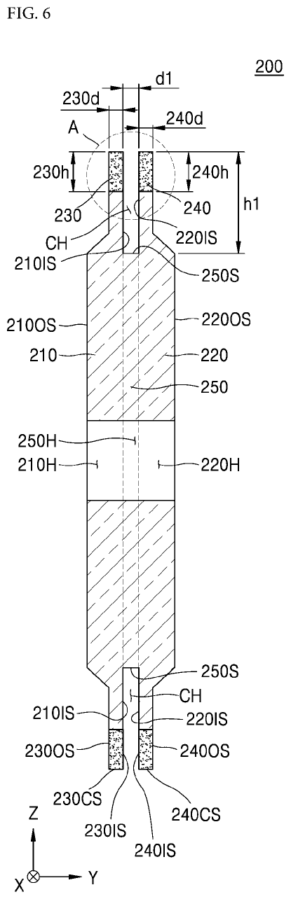

FIG. 4 is a perspective view of the cutting apparatus 200 of the glass laminated substrate 10 according to an embodiment of the inventive concept. FIG. 5 is a side view of the cutting apparatus 200 of the glass laminated substrate 10 according to an embodiment of the inventive concept. FIG. 6 is a cross-sectional view of the glass laminated substrate 10 according to an embodiment of the inventive concept.

Referring to FIGS. 4 to 6 altogether, the cutting apparatus 200 of the glass laminated substrate 10 according to an embodiment of the inventive concept may be an apparatus configured to cut the glass layer 13 of the glass laminated substrate 10 illustrated in FIG. 1.

For example, the cutting apparatus 200 of the glass laminated substrate 10 may be an apparatus configured to cut the glass layer 13 in a direction parallel to the direction, for example, the X direction, in which the first surface 13S1 of the glass layer 13 of the glass laminated substrate 10 extends.

The cutting apparatus 200 of the glass laminated substrate 10 may include a first rotating plate 210, a second rotating plate 220, a first cutter 230, a second cutter 240, and a connection member 250.

Furthermore, the cutting apparatus 200 of the glass laminated substrate 10 may have a channel CH that is a space surrounding an outer circumferential surface 250S of the connection member 250 between the first rotating plate 210 and the second rotating plate 220.

The first rotating plate 210 may be a plate configured to rotate around an axis in a direction parallel to a direction in which the first surface 13S1 of a glass layer 13S of the glass laminated substrate 10 extends. In an embodiment, when the first surface 13S1 of the glass layer 13S extends in the X direction and in the Y direction, the first rotating plate 210 may be configured to rotate around a first axis parallel to the Y direction. Furthermore, the first rotating plate 210 may move in the X direction while rotating around the first axis.

In an embodiment, the first rotating plate 210 may have a disc shape. The first rotating plate 210 may have an inner surface 2101S facing the second rotating plate 220 and an outer surface 2100S opposite to the inner surface 2101S. Furthermore, the first rotating plate 210 may have a first hole 210H at a center portion thereof. The first hole 210H of the first rotating plate 210 may be a space in which a rotation axis configured to provide a rotation force to the first rotating plate 210 is arranged.

In an embodiment, the first rotating plate 210 may include a metal material. For example, the first rotating plate 210 may include a metal material such as stainless steel.

The second rotating plate 220 may be a plate spaced apart from the first rotating plate 210 and facing the first rotating plate 210. For example, the first rotating plate 210 and the second rotating plate 220 may be apart from each other in in the Y direction.

Furthermore, the second rotating plate 220 may be a place configured to rotate around a first axis that is a rotation axis of the first rotating plate 210. The second rotating plate 220 may move in the X direction while rotating around the first axis with the first rotating plate 210.

Furthermore, the second rotating plate 220 may have substantially the same shape and size as those of the first rotating plate. For example, the second rotating plate 220 may be a disc having the same size as the first rotating plate 210. The second rotating plate 220 may have an inner surface 2201S facing the first rotating plate 210 and an outer surface 2200S opposite to the inner surface 2201S.

Furthermore, the second rotating plate 220 may have a second hole 220H at a center portion thereof. The second hole 220H of the second rotating plate 220 may spatially overlap the first hole 210H of the first rotating plate 210. Furthermore, the second hole 220H of the second rotating plate 220 may be a space in which a rotation axis configured to provide a rotation force to the second rotating plate 220 is arranged.

When the rotation axis is arranged in the first hole 210H of the first rotating plate 210 and the second hole 220H of the second rotating plate 220, as the rotation axis rotates around the first axis, the first rotating plate 210 and the second rotating plate 220 may rotate around the first axis.

In an embodiment, the second rotating plate 220 may include a metal material. For example, the second rotating plate 220 may include a metal material such as stainless steel.

In an embodiment, the first rotating plate 210 and the second rotating plate 220 may be connected to each other by the connection member 250. For example, the connection member 250 may be provided between the first rotating plate 210 and the second rotating plate 220 to connect the first rotating plate 210 to the second rotating plate 220.

In an embodiment, the connection member 250 may have a disc shape. Furthermore, the center of the connection member 250 may be located on substantially the same line as the centers of the first rotating plate 210 and the second rotating plate 220.

The connection member 250 may have a third hole 250H that spatially overlaps the first hole 210H of the first rotating plate 210 and the second hole 220H of the second rotating plate 220, at the center portions of the first rotating plate 210 and the second rotating plate 220. The first hole 210H, the second hole 220H, and the third hole 250H altogether may provide a space in which the rotation axis is arranged.

As the rotation axis arranged in the first hole 210H, the second hole 220H, and the third hole 250H rotates around the first axis, the first rotating plate 210, the second rotating plate 220, and the connection member 250, which are coupled to the first axis, may rotated around the first axis.

In an embodiment, the connection member 250 may include a metal material. For example, the connection member 250 may include a metal material such as stainless steel.

In an embodiment, the first rotating plate 210, the second rotating plate 220, and the connection member 250 may be integrally formed. In other words, the first rotating plate 210, the second rotating plate 220, and the connection member 250, which are integrally formed, may be handled as one component.

In an embodiment, the length in a Z direction of the connection member 250 may be less than the length in the Z direction of the first rotating plate 210 and the second rotating plate 220. In other words, when the cutting apparatus 200 is viewed on an X-Z plane, the area of the connection member 250 may be less than the area of the first rotating plate 210 and the second rotating plate 220.

Accordingly, the cutting apparatus 200 of the glass laminated substrate 10 according to an embodiment of the inventive concept may have the channel CH having a ring shape surrounding the outer circumferential surface 250S of the connection member 250 between the first rotating plate 210 and the second rotating plate 220.

The channel CH of the cutting apparatus 200 may be a ring shaped space defined by the inner surface 2101S of the first rotating plate 210, the inner surface 2201S of the second rotating plate 220, a first inner surface 2301S of the first cutter 230, a second inner surface 2401S of the second cutter 240, and the outer circumferential surface 250S of the connection member 250.

In the cutting process of the glass laminated substrate 10 using the cutting apparatus 200 according to an embodiment of the inventive concept, the channel CH of the cutting apparatus 200 may be an external discharge path of the glass debris D generated by the etching of the glass layer 13. In other words, while the cutting apparatus 200 cuts the glass laminated substrate 10, the glass debris D generated due to the etching of the glass layer 13 may be discharged to the outside through the channel CH of the cutting apparatus 200. Accordingly, in the cutting process of the glass laminated substrate 10 using the cutting apparatus 200, physical damage to the glass layer 13 due to the glass debris D may be prevented.

Furthermore, in the cutting process of the glass laminated substrate 10 using the cutting apparatus 200 according to an embodiment of the inventive concept, the channel CH of the cutting apparatus 200 may provide a space in which a cooling material flows. As the cooling material may flow through the channel CH, the first rotating plate 210, the second rotating plate 220, the first cutter 230, and the second cutter 240 may be cooled by the cooling material. Accordingly, the physical damage to the glass layer 13 due to frictional heat of the cutting apparatus 200 may be prevented.

The first cutter 230 may be coupled to an edge of the first rotating plate 210, and may surround the center portion of the first rotating plate 210. For example, the first cutter 230 may have a ring shape surrounding the edge of the first rotating plate 210. The first cutter 230 may have a first cutting surface 230CS facing the glass layer 13 during the cutting of the glass layer 13, the first inner surface 2301S extending from the first cutting surface 230CS facing the second rotating plate 220, and a first outer surface 2300S opposite to the first inner surface 2301S. Furthermore, the length in the Y direction of the first cutting surface 230CS of the first cutter 230 may be defined as a width 230d of the first cutter 230, and the length in the Z direction of the first inner surface 2301S of the first cutter 230 may be defined as a height 230h of the first cutter 230.

Furthermore, the first cutter 230 may be configured to rotate based on the rotation of the first rotating plate 210. The first cutter 230 may be configured to etch, by rotating, the glass layer 13 and at least a part of the adhesive layer 12 of the glass laminated substrate 10.

In an embodiment, the first cutter 230 may include a material having a stiffness greater than the material of the glass layer 13. For example, the first cutter 230 may include a diamond.

The second cutter 240 may be coupled to an edge of the second rotating plate 220, and may surround a center portion of the second rotating plate 220. For example, the second cutter 240 may have a ring shape surrounding the edge of the second rotating plate 220.

The second cutter 240 may include a second cutting surface 240CS facing the glass layer 13 during the cutting of the glass layer 13, the second inner surface 2401S extending from the second cutting surface 240CS facing the first rotating plate 210, and a second outer surface 2400S opposite to the second inner surface 2401S.

Furthermore, the length in the Y direction of the second cutting surface 240CS of the second cutter 240 may be defined as a width 240d of the second cutter 240, and the length in the Z direction of the second inner surface 2401S of the second cutter 240 may be defined as a height 240h of the second cutter 240.

Furthermore, the second cutter 240 may be configured to rotate based on the rotation of the second rotating plate 220. The second cutter 240 may be configured to etch, by rotating, the glass layer 13 and at least a part of the adhesive layer 12 of the glass laminated substrate 10.

Furthermore, the second cutter 240 may be spaced apart from the first cutter 230. For example, the first cutter 230 and the second cutter 240 may be spaced apart from each other in the Y direction, the first inner surface 2301S of the first cutter 230 and the second inner surface 2401S of the second cutter 240 may face each other.

In an embodiment, the second cutter 240 may include a material having a stiffness greater than the material of the glass layer 13. For example, the second cutter 240 may include a diamond.

According to an embodiment of the inventive concept, when the cutting apparatus 200 is viewed on the X-Z plane, the first cutter 230 and the second cutter 240 each may have a ring shape respectively surrounding the first rotating plate 210 and the second rotating plate 220.

Furthermore, when the cutting apparatus 200 is viewed on a Y-Z plane, as illustrated in FIG. 6, the first cutter 230 and the second cutter 240 each may have a rectangular shape. For example, a cross-sectional area on the X-Z plane of each of the first cutter 230 and the second cutter 240 may be uniform in the Z direction.

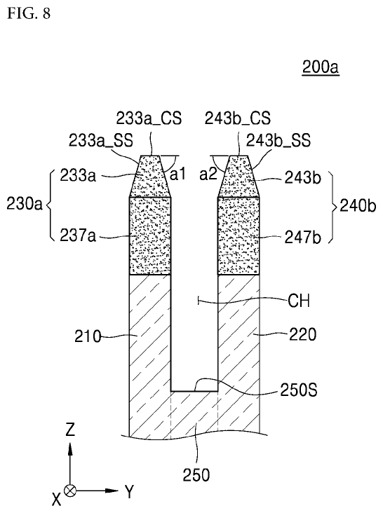

However, unlike the illustration of FIG. 6, the first cutter 230 and the second cutter 240 each may have a tapered shape in which a cross-sectional area thereof on the X-Z plane gradually decreases as the first cutter 230 and the second cutter 240 are away from the first axis that is the rotation axis in the Z direction. The first cutter 230 and the second cutter 240 each having a tapered shape are described below in detail with reference to FIGS. 8 to 10.

A depth h1 of the channel CH of the cutting apparatus 200 may be defined as the length of the channel CH in the Z direction. In detail, the depth h1 of the channel CH of the cutting apparatus 200 may be a separation distance between the first cutting surface 230CS of the first cutter 230 and the outer circumferential surface 250S of the connection member 250 in the Z direction.

In an embodiment, the depth h1 of the channel CH may be about 1.5 times to about 5.0 times greater than the height 230h of the first cutter 230 and the height 240h of the second cutter 240. For example, the depth h1 of the channel CH may be about 5.0 times greater than the height 230h of the first cutter 230 and the height 240h of the second cutter 240.

When the depth h1 of the channel CH is less than 1.5 times of the height 230h of the first cutter 230 and the height 240h of the second cutter 240, external discharge of the glass debris D generated due to the etching of the glass layer 13 by the first cutter 230 and the second cutter 240 may not be easy. Furthermore, in the cutting process of the glass laminated substrate 10 by using the cutting apparatus 200, cooling performance of the first cutter 230, the second cutter 240, the first rotating plate 210, and the second rotating plate 220 by using a cooling material may deteriorate.

Furthermore, when the depth h1 of the channel CH is less than about 5.0 times of the height 230h of the first cutter 230, in the cutting process of the glass laminated substrate 10 by using the cutting apparatus 200, vibrations of the first cutter 230 and the second cutter 240 may increase. Accordingly, the cutting surface of the glass laminated substrate 10 cut by the cutting apparatus 200 may not be smooth, and the structural reliability of the cutting apparatus 200 may deteriorate.

According to an embodiment of the inventive concept, as the depth h1 of the channel CH of the cutting apparatus 200 may be about 1.5 times to about 5.0 times greater than the height 230h of the first cutter 230 and the height 240h of the second cutter 240, the external discharge of the glass debris D generated due to the etching of the glass layer 13 by the first cutter 230 and the second cutter 240 may be easy, and the cooling performance of the first cutter 230, the second cutter 240, the first rotating plate 210, and the second rotating plate 220 by the cooling material may be improved.

Furthermore, in the cutting process of the glass laminated substrate 10 by using the cutting apparatus 200, the vibrations of the first cutter 230 and the second cutter 240 decrease so that the cutting surface of the glass laminated substrate 10 cut by the cutting apparatus 200 may be smooth.

In an embodiment, the cutting apparatus 200 of the glass laminated substrate 10 may have a symmetrical shape. For example, the cutting apparatus 200 of the glass laminated substrate 10 may be symmetrical with respect to the first axis that is the rotation axes of the first rotating plate 210 and the second rotating plate 220. In other words, the cutting apparatus 200 of the glass laminated substrate 10 may be symmetrical with respect to the first axis that passes in the Y direction the center portions of the first rotating plate 210, the second rotating plate 220, and the connection member 250.

Furthermore, the cutting apparatus 200 of the glass laminated substrate 10 may be symmetrical with respect to a second axis that is perpendicular to the first axis and passes the center of the connection member 250 and the outer circumferential surfaces 250S in a vertical direction. In other words, the cutting apparatus 200 of the glass laminated substrate 10 may be symmetrical with respect to the second axis that passes the center of the connection member 250 in the Z direction.

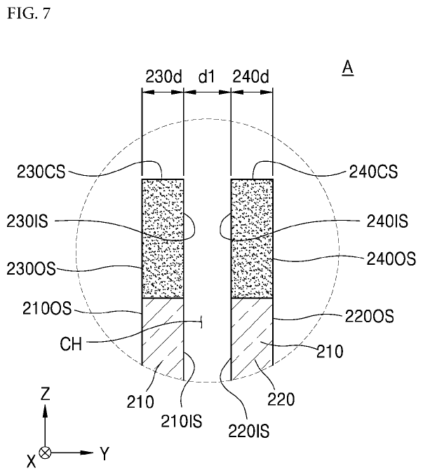

FIG. 7 is an enlarged view of a portion A of FIG. 6.

As described above, the length in the Y direction of the first cutting surface 230CS of the first cutter 230 and the length in the Y direction of the second cutting surface 240CS of the second cutter 240 may be defined as the width 230d of the first cutter 230 and the width 240d of the second cutter 240, respectively.

Furthermore, a width d1 of the channel CH of the cutting apparatus 200 may be defined as the length in the Y direction of the channel CH. In detail, the width d1 of the channel CH of the cutting apparatus 200 may be defined as a distance in the Y direction between the first inner surface 2301S of the first cutter 230 and the second inner surface 2401S of the second cutter 240.

Referring to FIG. 7, in an embodiment, the width 230d of the first cutter 230 and the width 240d of the second cutter 240 may be substantially the same. For example, the width 230d of the first cutter 230 and the width 240d of the second cutter 240 may have substantially the same value within a range of about 0.5 millimeters to about 3 millimeters.

In an embodiment, the width d1 of the channel CH of the cutting apparatus 200 may be about ⅔ times to about 2 times greater than each of the width 230d of the first cutter 230 and the width 240d of the second cutter 240. For example, when the width 230d of the first cutter 230 and the width 240d of the second cutter 240 are identically about 3 millimeters, the width d1 of the channel CH may be about 2 millimeters to 6 millimeters.

In general, the size of the glass debris D of the glass layer 13 generated due to the cutting of the glass laminated substrate 10 using the cutting apparatus 200 may be affected by the width 230d of the first cutter 230 and the width 240d of the second cutter 240. For example, the maximum length of the glass debris D may be within about ⅔ times of the width 230d of the first cutter 230 and the width 240d of the second cutter 240.

Accordingly, when the width d1 of the channel CH of the cutting apparatus 200 is less than about ⅔ times of the width 230d of the first cutter 230 and the width 240d of the second cutter 240, the external discharge of the glass debris D through the channel CH of the cutting apparatus 200 may deteriorate. Accordingly, the glass debris D collides with the glass layer 13 so that the glass layer 13 may be physically damaged.

Furthermore, when the width d1 of the channel CH of the cutting apparatus 200 exceeds about 2 times of the width 230d of the first cutter 230 and the width 240d of the second cutter 240, the vibrations of the first cutter 230 and the second cutter 240 may increase in the cutting process of the glass laminated substrate 10 by using the cutting apparatus 200.

Accordingly, the cutting surface of the glass laminated substrate 10 cut by the cutting apparatus 200 may not be smooth, and the structural reliability of the cutting apparatus 200 may deteriorate. Furthermore, the area of the glass laminated substrate wasted by the cutting of the cutting apparatus 200 may increase.

As the width d1 of the channel CH of the cutting apparatus 200 of the glass laminated substrate 10 according to an embodiment of the inventive concept is about ⅔ times to about 2 times greater than each of the width 230d of the first cutter 230 and the width 240d of the second cutter 240, the external discharge of the glass debris D through the channel CH of the cutting apparatus 200 may be improved.

Furthermore, in the cutting process of the glass laminated substrate 10, the vibrations of the first cutter 230 and the second cutter 240 may decrease, and the structural reliability of the cutting apparatus 200 may be improved. Accordingly, the cutting surface of the glass laminated substrate 10 cut by the cutting apparatus 200 may be smooth, and the wasted area of the glass laminated substrate 10 may be reduced.

In an embodiment, the width d1 of the channel CH of the cutting apparatus 200 may be greater than each of the width 230d of the first cutter 230 and the width 240d of the second cutter 240. For example, the width d1 of the channel CH of the cutting apparatus 200 may be about 1.1 times to about 2 times greater than each of the width 230d of the first cutter 230 and the width 240d of the second cutter 240.

In an embodiment, the width d1 of the channel CH of the cutting apparatus 200 may be substantially the same as the width 230d of the first cutter 230, and the width 240d of the second cutter 240. For example, the width d1 of the channel CH of the cutting apparatus 200, the width 230d of the first cutter 230, and the width 240d of the second cutter 240 may have substantially the same value within a range of about 0.5 millimeters to about 3 millimeters.

FIG. 8 is an enlarged view of a portion of a cutting apparatus 200a of the glass laminated substrate 10 according to an embodiment of the inventive concept.

In an embodiment, a first cutter 230a of the cutting apparatus 200a of the glass laminated substrate 10 may include a first processing portion 233a and a first connection portion 237a.

The first processing portion 233a of the first cutter 230a may be a part of the first cutter 230a that is directly involved in the cutting of the glass laminated substrate 10. In other words, the first processing portion 233a of the first cutter 230a may be a part of the first cutter 230a contacting the glass layer 13 and the adhesive layer 12 in the processing of the glass laminated substrate 10.

The first connection portion 237a of the first cutter 230a may be a part of the first cutter 230a that connects the first processing portion 233a of the first cutter 230a to the first rotating plate 210. Furthermore, the first connection portion 237a of the first cutter 230a may be a part of the first cutter 230a that is not in contact with the glass layer 13 and the adhesive layer 12 in the processing of the glass laminated substrate 10.

Furthermore, a second cutter 240b may include a second processing portion 243b and a second connection portion 247b. As the inventive concept of the second processing portion 243b and the second connection portion 247b of the second cutter 240b is redundant to that of the first processing portion 233a and the first connection portion 237a of the first cutter 230a, a detailed description thereof is omitted.

In an embodiment, the first processing portion 233a of the first cutter 230a and the second processing portion 243b of the second cutter 240b each may have a tapered shape in which a cross-sectional area thereof gradually decreases in a direction away from the outer circumferential surface 250S of the connection member 250 in the Z direction. In other words, the cross-sectional area on the X-Y plane of the first processing portion 233a of the first cutter 230a and the second processing portion 243b of the second cutter 240b may gradually decrease in a direction away from the outer circumferential surface 250S of the connection member 250 in the Z direction.

Furthermore, a material of the first processing portion 233a and the second processing portion 243b may include a diamond having a stiffness greater than the material of the glass layer 13.

In an embodiment, the thickness that is the length in the Z direction of the first processing portion 233a of the first cutter 230a and the second processing portion 243b of the second cutter 240b may be greater than the thickness dg of the glass layer 13 of the glass laminated substrate 10. For example, when the thickness of the glass layer 13 of the glass laminated substrate 10 is about 100 micrometers to about 150 micrometers, the thicknesses of the first processing portion 233a of the first cutter 230a and the second processing portion 243b of the second cutter 240b may exceed about 150 micrometers.

In an embodiment, the size of an inclination angle a1 formed by a first cutting surface 233a_CS and a first side surface 233a_SS of the first processing portion 233a of the first cutter 230a may be about 15° to about 75°. Furthermore, the size of an the inclination angle a2 formed by a second cutting surface 243b_CS and a second side surface 243b_SS of the second processing portion 243b of the second cutter 240b may also be about 15° to about 75°. Furthermore, the sizes of the inclination angles a1 and a2 of the first cutter 230a and the second cutter 240b may be substantially the same.

For example, when the size of each of the inclination angles a1 and a2 exceeds about 75°, in the cutting of the glass laminated substrate 10 using the cutting apparatus 200, friction is generated between the first and second cutters 230a and 240b and the glass layer 13 due to the vibration and tilt of the cutting apparatus 200, the glass layer 13 may be damaged.

Furthermore, when the size of each of the inclination angles a1 and a2 is less than 15°, in the cutting of the glass laminated substrate 10 using the cutting apparatus 200, visibility of a tapered shape of the cutting surface of the glass laminated substrate may be increased. In other words, when the glass laminated substrate 10 is seen in a horizontal view, the cutting surface may be recognized to be an inclined surface, not to be a surface perpendicular to the first surface 13S1 of the glass layer 13.

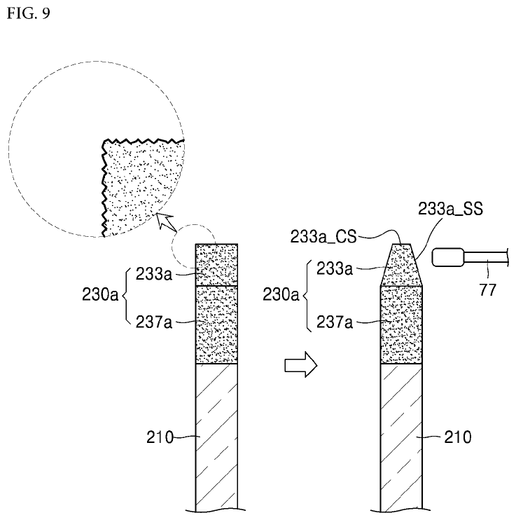

FIG. 9 is a view showing a method of manufacturing the first cutter 230a of the cutting apparatus 200a of the glass laminated substrate 10 of FIG. 8.

Referring to FIG. 9, the first processing portion 233a of the first cutter 230a of the cutting apparatus 200a may be a part of the first cutter 230a ground by a grinder 77. Accordingly, the first processing portion 233a of the first cutter 230a may have a tapered shape in which a cross-sectional area thereof gradually decreases in a direction away from the outer circumferential surface 250S of the connection member 250 in the Z direction.

Furthermore, as a surface of the first processing portion 233a of the first cutter 230a is ground by the grinder 77, the roughness of the first processing portion 233a of the first cutter 230a may be less than the roughness of the first connection portion 237a. In other words, while the first connection portion 237a of the first cutter 230a is not ground by the grinder 77, the first processing portion 233a may be ground by the grinder 77, and thus the surface of the first processing portion 233a may be smoother than the surface of the first connection portion 237a.

Accordingly, the cutting surface of the glass laminated substrate 10 cut by the first cutter 230a of the cutting apparatus 200a may be smooth.

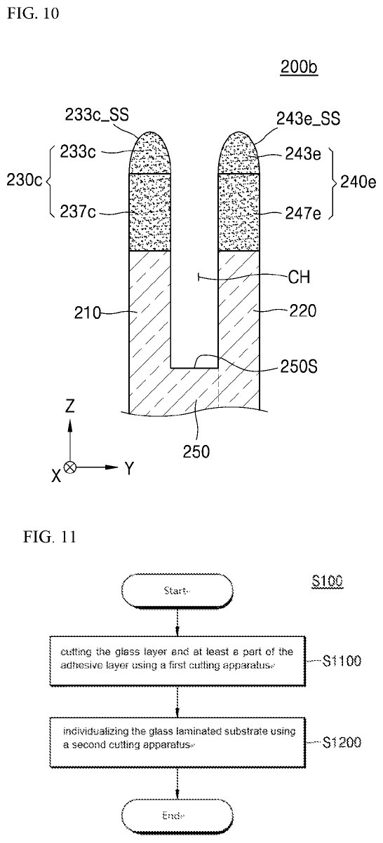

FIG. 10 is an enlarged view of a portion of a cutting apparatus 200b of the glass laminated substrate 10 according to an embodiment of the inventive concept.

In an embodiment, each of a third processing portion 233c of a third cutter 230c and a fourth processing portion 243e of a fourth cutter 240e may having a tapered shape in which such that a cross-sectional area thereof gradually decreases in a direction away from the outer circumferential surface 250S of the connection member 250 in the Z direction.

In an embodiment, when the cutting apparatus 200b is viewed on the Y-Z plane, a third side surface 233c_SS of the third processing portion 233c may have a curved surface. In other words, each of the third side surface 233c_SS of the third processing portion 233c of the third cutter 230c and a fourth side surface 243e_SS of the fourth processing portion 243e of the fourth cutter 240e may have an inclination that is gentle in a direction away from the outer circumferential surface 250S of the connection member 250 in the Z direction.

In an embodiment, when the cutting apparatus 200b is viewed on the Y-Z plane, each of the third processing portion 233c of the third cutter 230c and the fourth processing portion 243e of the fourth cutter 240e may have a semicircular shape.

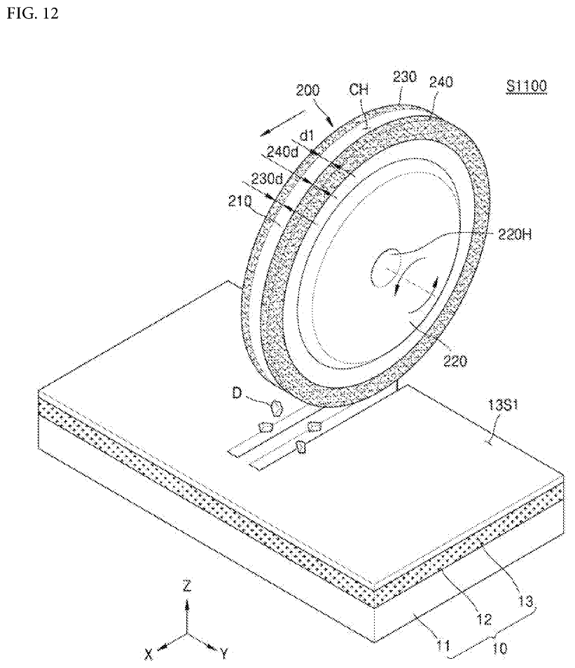

FIG. 11 is a flowchart of a method (S100) of cutting the glass laminated substrate 10 according to an embodiment of the inventive concept. FIGS. 12 to 16 are views of the respective operations of the method S100 of cutting the glass laminated substrate 10 according to an embodiment of the inventive concept.

Referring to FIG. 11, the method S100 of cutting the glass laminated substrate 10 according to an embodiment of the inventive concept may include cutting the glass layer 13 and at least a part of the adhesive layer 12 using a first cutting apparatus 200 that is the cutting apparatus 200 (S1100), and individualizing the glass laminated substrate 10 using a second cutting apparatus 500 (S1200).

FIG. 12 is a view of the operation S1100 of cutting the glass layer 13 and at least a part of the adhesive layer 12 using the first cutting apparatus 200.

Referring to both FIGS. 11 and 12, the operation S1000 may be the cutting of the glass layer 13 and at least a part of the adhesive layer 12 of the glass laminated substrate 10 using the first cutting apparatus 200 described with reference to FIGS. 4 to 7. As the inventive concept of the first cutting apparatus 200 is redundant to the description presented with reference to FIGS. 4 to 7, a detailed description thereof is omitted.

In an embodiment, in the operation S1100, the first rotating plate 210, the second rotating plate 220, and the connection member 250 of the first cutting apparatus 200 may rotate around the first axis extending in the Y direction. Furthermore, while the first rotating plate 210, the second rotating plate 220, and the connection member 250 of the first cutting apparatus 200 rotate around the first axis, the first cutting apparatus 200 may move in the X direction that is perpendicular to the first axis.

In other words, in the operation S1100, while rotating around the first axis extending in the Y direction, the first cutting apparatus 200 may move in the X direction crossing the glass laminated substrate 10. When the first cutting apparatus 200 moves in the X direction, the first cutter 230 and the second cutter 240 of the first cutting apparatus 200 may remove the glass layer 13 and at least a part of the adhesive layer 12.

In an embodiment, in the operation S1100, a cooling material may be provided to cool the glass laminated substrate 10 and the first cutting apparatus 200. For example, the cooling material may be sprayed onto the first surface 13S1 of the glass laminated substrate 10 and a surface of the first cutting apparatus 200. For example, the cooling material may include cooling water or cooling oil.

In an embodiment, the channel CH of the first cutting apparatus 200 may provide a space for flowing the cooling material. As the cooling material may flow in the channel CH of the first cutting apparatus 200, the first rotating plate 210, the second rotating plate 220, the first cutter 230, and the second cutter 240 may be cooled. Accordingly, the physical damage to the glass layer 13 due to the frictional heat of the cutting apparatus 200 may be prevented.

Furthermore, when the glass laminated substrate 10 is cut by the first cutting apparatus 200, the glass debris D of the glass layer 13 may be generated. The size of the glass debris D of the glass layer 13 generate by the cutting of the glass laminated substrate 10 may be within about ⅔ times of the width 230d of the first cutter 230 and the width 240d of the second cutter 240.

In an embodiment, the width d1 of the channel CH of the first cutting apparatus 200 may be about ⅔ times to about 2 times greater than each of the width 230d of the first cutter 230 and the width 240d of the second cutter 240.

In an embodiment, first in the cutting process of the glass laminated substrate using the cutting apparatus 200, the channel CH of the first cutting apparatus 200 may be an external discharge path of the glass debris D generated due to the etching of the glass layer 13.

As the width d1 of the channel CH of the first cutting apparatus 200 may be about ⅔ times to about 2 times greater than each of the width 230d of the first cutter 230 and the width 240d of the second cutter 240, the external discharge of the glass debris D through the channel CH may be facilitated.

In other words, while the first cutting apparatus 200 cuts the glass laminated substrate 10, the glass debris D generated due to the etching of the glass layer 13 may be discharged to the outside through the channel CH of the first cutting apparatus 200. Accordingly, first in the cutting process of the glass laminated substrate 10 using the cutting apparatus 200, the physical damage to the glass layer 13 due to the glass debris D may be prevented.

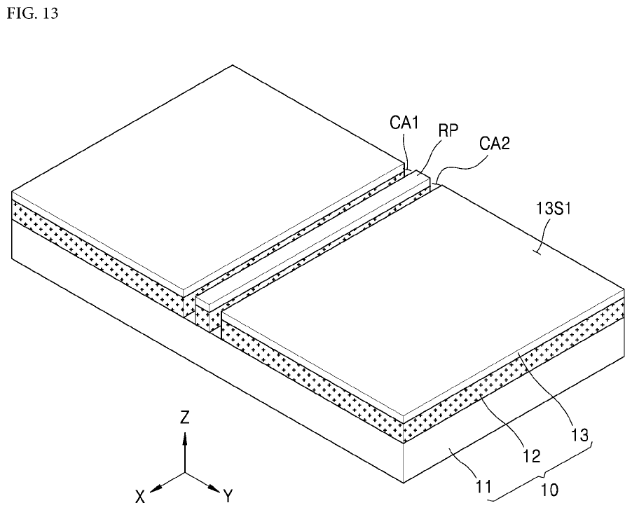

FIG. 13 is a view of the glass laminated substrate 10 that is partially cut by the first cutting apparatus 200.

Referring to FIG. 13, the glass laminated substrate 10 may have a first cutting space CA1 generated by the first cutter 230 of the first cutting apparatus 200, and a second cutting space CA2 generated by the second cutter 240 of the first cutting apparatus 200. Furthermore, the glass laminated substrate 10 may have a remaining portion RP between the first cutting space CA1 and the second cutting space CA2.

In an embodiment, the width of the first cutting space CA1 may be substantially the same as the width 230d of the first cutter 230, and the width of the second cutting space CA2 may be substantially the same as the width 240d of the second cutter 240. Furthermore, the width of the remaining portion RP may be substantially the same as the width d1 of the channel CH.

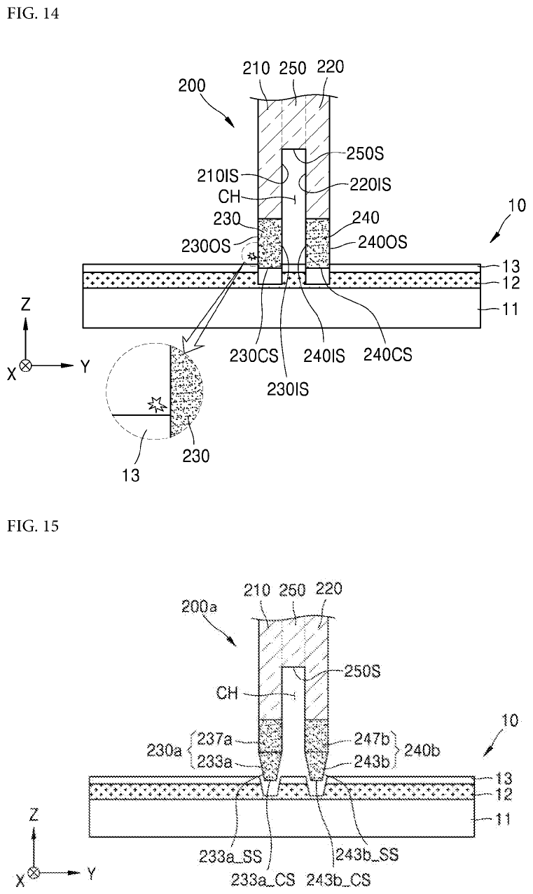

FIGS. 14 and 15 are views of the operation S1100 of cutting the glass layer 13 and at least a part of the adhesive layer 12 using the first cutting apparatuses 200, 200a, and 200b, according to an embodiment of the inventive concept.

Referring to FIG. 14, the operation S1100 may be the cutting of the glass layer 13 and at least a part of the adhesive layer 12 using the cutting apparatus 200 described with reference to FIGS. 4 to 7.

In the operation S1100, when the cutting apparatus 200 vibrates or tilts in the Z direction in the operation of cutting the glass laminated substrate 10, the glass layer 13 may be physically damaged due to the friction between the cutting apparatus 200 and the glass layer 13.

Referring to FIG. 15, the operation S1100 may be the operation of cutting the glass layer 13 and at least a part of the adhesive layer 12 using the cutting apparatus 200a and 200b described with reference to FIGS. 8 to 10.

A processing portion 233a of the first cutter 230a and a processing portion 243b of the second cutter 240b of the first cutting apparatus 200a used in in the operation S1100 each may have a tapered shape in which a cross-sectional area thereof gradually decreases in a direction away from the outer circumferential surface 250S of the connection member 250 in the Z direction.

In other words, the cross-sectional area on the X-Y plane of each of the processing portion 233a of the first cutter 230a and the processing portion 243b of the second cutter 240b may gradually decrease in a direction away from the outer circumferential surface 250S of the connection member 250 in the Z direction.

In an embodiment, when the first cutting apparatus 200a moves in the operation of cutting the glass laminated substrate 10 in the +Z direction, a gap in a horizontal direction may be formed between the processing portion 233a of the first cutter 230a and the first cutting space CA1 and between the processing portion 243b of the second cutter 240b and the second cutting space CA2.

Accordingly, even when the first cutting apparatus 200a vibrates or tilts in the operation of cutting the glass laminated substrate 10 in the Z, the friction between the first cutting apparatus 200a and the glass layer 13 may be prevented, and thus the physical damage to the glass laminated substrate 10 may be prevented.

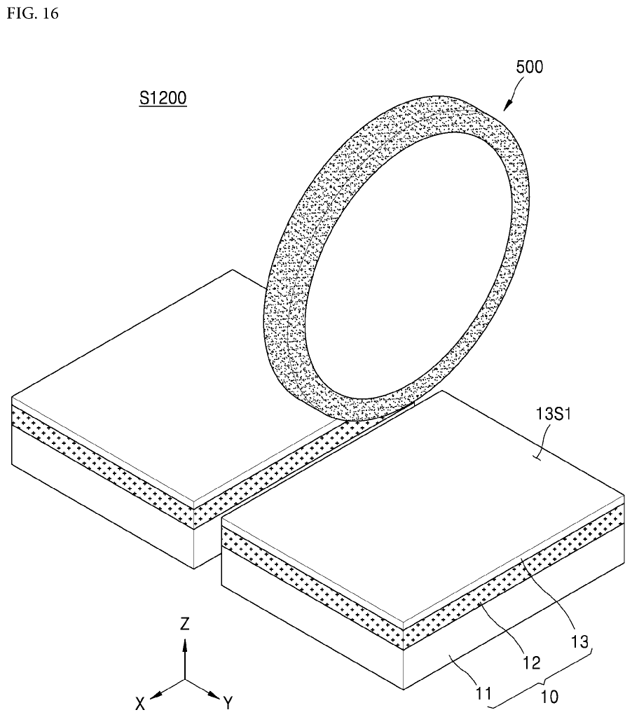

FIG. 16 is a view of an operation (S1200) of individualizing the glass laminated substrate 10 using the second cutting apparatus 500.

In an embodiment, in the operation S1200, the second cutting apparatus 500, when located in any one space of the first cutting space CA1 and the second cutting space CA2, may rotate around the axis in the Y direction and simultaneously move in the X direction. As the second cutting apparatus 500 moves in the X direction, the adhesive layer 12 and the substrate 11 may be removed.

Furthermore, in the operation S1200, the second cutting apparatus 500 may remove the remaining portion RP. For example, when the second cutting apparatus 500 rotates around the axis in the Y direction and simultaneously moves in the X direction, the second cutting apparatus 500 may remove the glass layer 13, the adhesive layer 12, and the substrate 11.

In the operation S1200, when the second cutting apparatus 500 completely traverses the glass laminated substrate 10, the individualization of the glass laminated substrate 10 by the second cutting apparatus 500 may be completed.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

1. An apparatus for cutting a glass laminated substrate, the apparatus comprising:
a first rotating plate configured to rotate around a first axis extending in a first direction parallel to a direction in which an upper surface of the glass laminated substrate extends;
a first cutter coupled to an edge of the first rotating plate;
a second rotating plate disposed apart from the first rotating plate in the first direction and configured to rotate around the first axis;
a second cutter coupled to an edge of the second rotating plate and disposed apart from the first cutter in the first direction; and
a connection member interposed between the first rotating plate and the second rotating plate and configured to rotate around the first axis,
wherein a channel having a ring shape surrounding an outer circumferential surface of the connection member is formed between the first rotating plate and the second rotating plate.

2. The apparatus of claim 1, wherein the first rotating plate, the second rotating plate, and the connection member are integrally formed.

3. The apparatus of claim 1, wherein the apparatus has a symmetrical shape with respect to the first axis that passes the centers of the first rotating plate, the second rotating plate, and the connection member.

4. The apparatus of claim 3, wherein the apparatus has a symmetrical shape with respect to a second axis that is perpendicular to the first axis and vertically passes the center and the outer circumferential surface of the connection member.

5. The apparatus of claim 1, wherein
a width of the first cutter in the first direction is identical to a width of the second cutter in the first direction, and
a width of the channel in the first direction is ⅔ times to two times greater than the width of each of the first cutter and the second cutter.

6. The apparatus of claim 1, wherein
a width of the channel in the first direction is greater than a width of each of the first cutter and the second cutter.

7. The apparatus of claim 1, wherein
a width of the first cutter in the first direction, a width of the second cutter in the first direction, and a width of the channel in the first direction are identical to one another.

8. The apparatus of claim 1, wherein
the first cutter and the second cutter each have a tapered shape in which a cross-sectional area of each of the first cutter and the second cutter on a plane perpendicular to a second direction gradually decreases in the second direction, the second direction being a direction away from the outer circumferential surface of the connection member.

9. The apparatus of claim 1, wherein
a direction perpendicular to the first direction and being away from the outer circumferential surface of the connection member is defined as a second direction, and
a depth of the channel in the second direction is 1.5 times to 5 times greater than each of a thickness of the first cutter in the second direction and a thickness of the second cutter in the second direction.

10. An apparatus for cutting a glass laminated substrate in which a substrate, an adhesive layer, and a glass layer are sequentially stacked, the apparatus comprising:
a first rotating plate configured to rotate around a first axis extending in a direction parallel to a first direction in which a surface of the glass laminated substrate extends;
a first cutter coupled to an edge of the first rotating plate to surround a center portion of the first rotating plate and configured to process the glass layer and a portion of the adhesive layer;
a second rotating plate disposed apart from the first rotating plate in the first direction and configured to rotate around the first axis;
a second cutter coupled to an edge of the second rotating plate to surround a center portion of the second rotating plate and configured to process the glass layer and a portion of the adhesive layer;
a connection member interposed between inner surfaces of the first rotating plate and the second rotating plate and configured to rotate around the first axis,
wherein a channel having a ring shape surrounding an outer circumferential surface of the connection member is formed between the first rotating plate and the second rotating plate, glass debris of the glass layer that is cut by the first cutter and the second cutter being discharged through the channel.

11. The apparatus of claim 10, wherein
the first rotating plate, the second rotating plate, and the connection member are integrally formed, and
the apparatus has a symmetrical shape with respect to the first axis that passes through centers of the first rotating plate, the second rotating plate, and the connection member.

12. The apparatus of claim 11, wherein the apparatus has a symmetrical shape with respect to a second axis that is perpendicular to the first axis and vertically passes through the center and the outer circumferential surface of the connection member.

13. The apparatus of claim 10, wherein
a direction perpendicular to the first direction and passing through a center and the outer circumferential surface of the connection member is defined as a second direction, the first cutter comprises:
a first processing portion that comes into contact with the glass layer and the adhesive layer during processing of the glass laminated substrate and includes a diamond; and a first connection portion connecting the first processing portion to the first rotating plate, the second cutter comprises:
a second processing portion that comes into contact with the glass layer and the adhesive layer during the processing of the glass laminated substrate and includes a diamond; and a second connection portion connecting the second processing portion to the second rotating plate, and
a thickness of the first processing portion in the second direction and a thickness of the second processing portion in the second direction each are greater than a thickness of the glass layer.

14. The apparatus of claim 13, wherein, when a thickness of the glass layer of the glass laminated substrate is 100 micrometers to 150 micrometers, the thickness of the first processing portion of the first cutter and the thickness of the second processing portion of the second cutter each exceed 150 micrometers.

15. The apparatus of claim 13, wherein the first processing portion and the second processing portion each have a tapered shape in which a cross-sectional area of each of the first processing portion and the second processing portion on a plane perpendicular to the second direction gradually decreases in the second direction, the second direction being a direction away from the outer circumferential surface of the connection member.

16. The apparatus of claim 15, wherein
the first processing portion of the first cutter comprises a first cutting surface facing the glass laminated substrate and a first side surface extending from the first cutting surface, the second processing portion of the second cutter comprises a second cutting surface facing the glass laminated substrate and a second side surface extending from the second cutting surface, and
an inclination angle formed by the first cutting surface and the first side surface of the first processing portion and an inclination angle formed by the second cutting surface and the second side surface of the second processing portion are each are 15° to 75°.

17. The apparatus of claim 13, wherein
a surface roughness of the first processing portion of the first cutter is less than a surface roughness of the first connection portion, and
a surface roughness of the second processing portion of the second cutter is less than a surface roughness of the second connection portion.

18. The apparatus of claim 10, wherein
a width of the first cutter in the first direction is identical to a width of the second cutter in the first direction, and
a width of the channel in the first direction is ⅔ times to 2 times greater than the width of each of the first cutter and the second cutter.

19. The apparatus of claim 18, wherein the width of the first cutter in the first direction, the width of the second cutter in the first direction, and the width of the channel in the first direction are identical to one another.

20. The apparatus of claim 19, wherein the width of the first cutter in the first direction, the width of the second cutter in the first direction, and the width of the channel in the first direction each are 0.5 millimeters to 3 millimeters.
